(19) United States
(12) Patent Application Publication
(10) Pub. No.: US 2004/0034186 A1
(43) Pub. Date: Feb. 19, 2004

(54) Novel initiator for polymerizing polyisocyanate

(75) Inventors: Jae-Suk Lee, Gwangju (KR); Jun-Hwan Ahn, Gwangju (KR)

Correspondence Address: Finnegan, Henderson, Farabow,, Garrett & Dunner, L.L.P., 1300 I Street, N.W., Washington, DC, 20005-3315, US

(73) Assignee: KWANGJU INSTITUTE OF SCIENCE AND TECHNOLOGY.

(21) Appl. No.: 10/641,106

(22) Filed: Aug. 15, 2003

(30) Foreign Application Priority Data
Apr. 17, 2002 (KR) 2002-20926

(51) Int. Cl. C08G 18/00

(52) U.S. Cl. 528/44; 556/1

(57) ABSTRACT

The present invention relates to a novel initiator for polymerizing polyisocyanate, more particularly to a metal amidate represented by the following Formula 1, which is useful for polymerizing polyisocyanate having a variety of functional groups, including alkyl and aryl, by anionic living polymerization. While the conventional initiators caused generation of dimer and trimer byproducts, the new initiator of the present invention facilitates polymerization of polyisocyanates having a variety of functional groups, including alkyl and aryl, since the amidate anion has a low reactivity, so that the control of initial initiation reaction rate and chain growth rate is easy, and the control of monodispersity and molecular weight is facile:

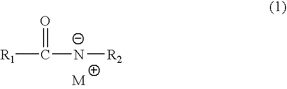

wherein M is an alkali metal such as Li, Na, K, and Cs, and R1 and R2 are independently an alkyl or aryl group group.

### BACKGROUND OF THE INVENTION

1. Field of the Invention

The present invention relates to a novel initiator for polymerizing polyisocyanate, and more particularly, to a metal amidate represented by the following Formula 1, which is useful for polymerizing polyisocyanate having a variety of functional groups, including alkyl and aryl, by anionic living polymerization. While the conventional initiators produced dimer and trimer byproducts, the novel initiator of the present invention facilitates polymerization of polyisocyanates having a variety of functional groups, including alkyl and aryl, since the amidate anion has a low reactivity, so that the control of initial initiation reaction rate and chain growth rate is easy, and the control of monodispersity and molecular weight is facile:

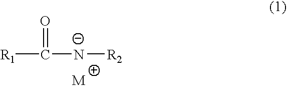

wherein M is an alkali metal such as Li, Na, K, and Cs; and R1 and R2 are independently an alkyl or aryl group.

2. Description of the Related Art

In general, polyisocyanates are prepared by anionic polymerization [Bur, A. J.; Fetters, L. J. Chem. Rev. 1976, 76, 727.]. A typical polymerization condition is polymerization at −60° C. using NaCN initiator and N,N-dimethylformamide (DMF) solvent. However, in anionic polymerization of polyisocyanates, the terminal active anion tends to attack the carbonyl group of the main chain, thereby forming a thermodynamically stable trimer, as in polymerization of methyl methacrylate (MMA), which is also a polar polymer. As a result, it is difficult to control the molecular weight and monodispersity of the polymer. In addition, an extreme reaction condition such as a high-degree vacuum or an extremely low temperature is required, since the isocyanate monomer is highly reactive.

The control of polymerization of polyisocyanates has been a challenging task for many researchers. There have been many researches for preparing polyisocyanates with controlled structure by anionic polymerization.

For example, Fukuwatari et al. have polymerized n-hexylisocyanate by anionic polymerization using lanthanoid isopropoxide as an initiator [Fukuwatari, N.; Sugimoto, H.; Inoue, S. Macromol. Rapid Commun. 1996, 17]. The polymer yield was 90% at a polymerization temperature of −78° C. While the polymer yield is low in the general polymerization at a temperature higher than −40° C. due to trimerization, a polymer yield as high as 73% was obtained at −30° C. Therefore, it was proved that lanthanoid isopropoxide is a more effective initiator than NaCN and also that polymerization at a relatively higher temperature is possible.

Tsuyosi et al. have prepared a homopolymer of polyhexylisocyanate at room temperature using yttrium isopropoxide as an initiator [Ikeda, T.; Sugimoto, H.; Inoue, S. J. M. S.-Pure Appl. Chem., 1997, A(34), 1907.]. Although this polymerization offered an improved polymer yield, the control of molecular weight and monodispersity was difficult and it was impossible to find a condition for living polymerization.

Another difficulty raised in polymerization of polyisocyanates is solubility to a solvent. That is, the solubility of a monomer and the obtained polymer to dimethylformamide (DMF), a commonly used solvent, at low temperature is not good, so that the molecular weight distribution becomes broad and the yield decreases. In order to overcome this problem, Okamoto et al. used a co-solvent comprising toluene and DMF. As a result, the yield was improved, but no noticeable improvement was observed in molecular weight distribution. Use of tetrahydrofuran (THF) solvent was proposed to overcome this solubility problem, but it aggravated the trimerization problem. Wang et al. have synthesized polyisocyanates using SmI₂, which is a lanthanide compound [J. Wang, R. Nomura, R. Endo, Macromolecules, 1996, 29, 2707: Chemistry Letter, 1996,10, 909]. But the yield was as low as 32 to 70%, and the molecular weight distribution was uncontrollable. Novak et al. have prepared a variety of isocyanates by living coordination polymerization using CpTiCL₂ (OR), etc. [T. E. Pattern, B. M. Novak. J. of Am. Soc. 1991, 113, 5065: Macromolecules, 1993, 26, 436: Macromolecules, 1996, 29, 5882]. However, a catalyst system, which is very complex and expensive, should be used for the coordination polymerization. In addition, the yield is still lower than 100%, and copolymerization with other monomers is not possible.

Okamoto et al. have polymerized aromatic polyisocyanates under a polymerization condition of tetrahydrofuran solvent and −98° C., using chiral lithium amides of (S)-(−)-(2-methoxymethyl)pyrrolidone and (S)-(+)-(2-pyrrolidonylmethyl)pyrrolidone, or chiral alkoxides of 1,2,5,6-diisopropylidene-D-glucose, (−)-menthol, (−)-borneol, and (2S, 3R)-(+)-4-dimethylamino-1,2-diphenyl-3-methyl-2-butanol. However, they did not take into considerations of parameters related with the living condition and structure control, such as reaction time, counter ions, and the like.

The present inventors have disclosed a method for preparation of polyisocyanates having an alkoxy silyl group in Korea Patent Publication No. 2000-38060. But, the patent is limited to preparation of polyisocyanates having an alkoxy silyl group. And, although the isocyanate having an silyl group, which was used as a monomer in Korea Patent Publication No. 2000-38060, has a good solubility to tetrahydrofuran, isocyanate monomers having other functional groups, such as hexylisocyanate, have relatively lower solubilities, so that the prevention of trimerization using 15-crown ether-5 is ineffective. Also, since the isocyanate monomer having an alkoxy silyl group has a huge structure, the steric hindrance effect by 15-crown ether-5 is not significant for isocyanate monomers having other functional groups, such as hexylisocyanate, which have relatively small structures. Korea Patent Publication No. 2002-69307 discloses a method for preparation of polyisocyanates having a variety of functional groups by reaction of isocyanate monomers having a variety of functional groups and a metal ion initiator with additives at a high-degree vacuum and very low temperature. In this invention, a common ion salt to the metal ion was used to prevent trimerization. As a result, the molecular weight control became possible and physical properties of the polyisocyanates were improved. However, use of the carboanion initiator resulted in inhomogeneity in initiation reaction and growth reaction, and use of an additive made the preparation process more complex.

### SUMMARY OF THE INVENTION

As described above, the conventional methods for preparing polyisocyanates are difficult to control the molecular weight due to generation of dimerization or trimerization, offer a low yield, and a broad molecular weight distribution and thus a new method for preparing polyisocyanates is highly needed.

Therefore, it is an object of the present invention to provide a condition for preparing polyisocyanates having a variety of functional groups, including alkyl and aryl, by polymerizing isocyanate monomers having a variety of functional groups, including alkyl and aryl, at a high-degree vacuum and an extremely low temperature using metal amidate anion (RC(═O)N—), which is a novel metal ion initiator, in order to prevent side reactions (trimerization and dimerization) due to the low reactivity of the amidate anion, and to make the monodispersity and molecular weight more controllable.

### BRIEF DESCRIPTION OF THE DRAWINGS

FIG. 1 is a ¹H-NMR spectrum of poly(n-hexylisocyanate) prepared in Example 3 according to the present invention.

FIG. 2 is a FT-IR spectrum of n-hexylisocyanate and poly(n-hexylisocyanate) prepared in Example 3 according to the present invention.

FIG. 3 is a GPC spectrum of n-hexylisocyanate and poly(n-hexylisocyanate) prepared in Example 3 according to the present invention.

FIG. 4 is a graph that shows molecular weights of poly(n-hexylisocyanate) prepared in Examples 7 to 10, depending on the monomer/initiator ratio.

### DETAILED DESCRIPTION OF THE PREFERRED EMBODIMENTS

The present invention is characterized by an initiator for polymerizing polyisocyanate represented by the following Formula 1:

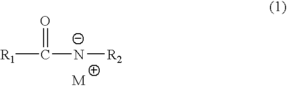

wherein M is an alkali metal including Li, Na, K, and Cs; and R1 and R2 are independently an alkyl or aryl group.

The present invention also relates to a method for preparing polyisocyanate by anionic polymerization at high-degree vacuum of 10⁻⁶ to 10⁻⁴ mmHg and an extremely low temperature of −60 to −100° C. for 1 to 240 minutes using the metal amidate initiator represented by Formula 1, isocyanate monomer, and a tetrahydrofuran solvent.

Hereinafter, the present invention is described in more detail.

The metal amidate represented by Formula 1 is a known compound, but it has never been used as a polymerization initiator as in the present invention. Accordingly, the present invention provides a novel use of the metal amidate represented by Formula 1 as a polymerization initiator.

For the metal amidate initiator represented by Formula 1, alkali metal salts such as lithium salt, sodium salt, potassium salt, and cesium salt can be used, preferably a sodium salt. The initiator comprises a cationic part and an anionic part. The relative stability of the anionic part varies greatly depending on the cation. In general, the stability increases in the order of carboanion (C⁻)<nitrogen anion (N⁻)<oxyanion (O⁻)<phophine anion (P⁻). This tendency is adversely proportional to the reactivity of anions. Therefore, the highly reactive carboanion, which has been used dominantly until now, causes many side reactions at the early reaction step by dimerization or trimerization of radical anions. On the contrary, since the amidate anion is relatively less reactive, it is easier to control the initial initiation reaction rate and the chain growth rate.

Accordingly, if the polyisocyanate is polymerized using the metal amidate represented by Formula 1 as a polymerization initiator, it is easy to control the molecular weight and molecular weight distribution, and the preparation process can be simplified.

The metal amidate represented by Formula 1 can be prepared by a common method as shown in the following Scheme 1:

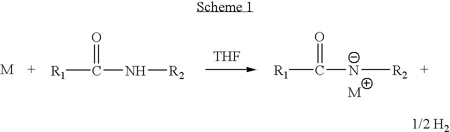

wherein M an alkali metal including Li, Na, K, and Cs; and R1 and R2 are independently an alkyl or aryl group.

According to the Scheme 1, an amide is reacted with an equivalent alkali metal to prepare the metal amidate represented by Formula 1. The hydrogen gas is removed at high vacuum, and the reaction time is performed for about 24 hours. Preferably, M is sodium (Na), and each of R₁ and R₂ is C₁ to C₂₀ alkyl, phenyl, trifluoroalkylphenyl, or naphthalene, in the metal amidate represented by Formula 1.

The present invention also provides a method for polymerizing polyisocyanate using the initiator represented by Formula 1. The polymerization is carried out at high-degree vacuum of 10⁻⁶ to 10⁻⁴ mmHg and very low temperature of −60 to −100° C. for 30 to 150 minutes using isocyanate monomer and a tetrahydrofuran solvent.

For the isocyanate monomer used in the polymerization according to the present invention, both aliphatic and aromatic isocyanates can be used. Besides, isocyanates substituted by various functional groups can be used. For the polymerization solvent, various organic solvents can be used. Particularly, tetrahydrofuran (THF) which dissolves the isocyanate monomer very well, is preferable.

The following Scheme 2 is a specific example of the polymerization of a polyisocyanate according to the present invention:

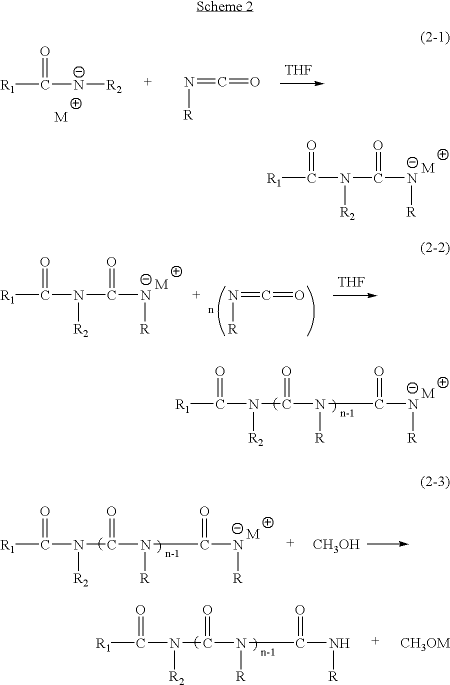

wherein M is an alkali metal including Li, Na, K, and Cs; R1 and R2 are independently an alkyl or aryl group, and R is an aliphatic or aromatic group.

Hereunder is given a more detailed description about the polymerization according to the Scheme 2.

The Scheme 2-1 is an initiation step. At first, the initiator exists in the metal amidate state. When an isocyanate monomer is fed, amidate anion attacks the O═C═N— part of the monomer.

The Scheme 2-2 is a chain growth step. As the monomer is fed continuously, the chain grows as the isocyanate anion attacks the O═C═N— part of the monomer.

The Scheme 2-3 is a termination step. When the chain has grown sufficiently, methanol is fed instead of the isocyanate monomer to terminate the polymerization.

The molecular weight of the polyisocyanate prepared according to the Scheme 2 can be controlled by the amount of the initiator and the monomer. For example, if the initial amount of the initiator is 0.1 mmol and that of the monomer is 2 mmol, the molecular weight can be controlled considering that 20 monomers can attach to one initiator.

Also, a homopolymer of polyisocyanate with controlled molecular weight and molecular weight distribution can be prepared using the metal amidate represented by Formula 1 initiator, or a post block copolymer with other monoisocyanate monomer can be prepared using the initiator represented by Formula 1. Alternatively, a block copolymer of ethylene oxide, propylene oxide, cyclic silane, etc. with controlled structure can be prepared using the initiator represented by Formula 1 and the amidate anion. Accordingly, a homopolymer and a copolymer of polyisocyanate can be prepared easily using the polymerization method of the present invention.

As explained in detail above, the initiator according to the present invention, which is represented by Formula 1, is a relatively stable amidate anion. Since it has a low reactivity, it forms a uniform reaction system and prevents side reactions (trimerization and dimerization) at the early reaction step. Also, because the control of monodispersity and molecular weight is easier, a polyisocyanate polymer having a variety of functional groups, including alkyl and aryl, and controlled structure can be prepared under a stable condition.

Hereinafter, this invention is explained in more detail based on the following Examples but they should not be construed as limiting the scope of this invention.

### EXAMPLES

### Examples 1 to 6 and Comparative Examples 1 to 3

Poly(n-hexylisocyanate) was prepared as follows using n-hexylisocyanate (HIC) shown in the following Table 1. The reaction condition was −90 to −100° C. and 10⁻⁶ mmHg, and the reaction time was 1 to 100 minutes. To set the reaction temperature, liquid nitrogen was added to methanol contained in a constant-temperature bath, and the temperature was measured using a low-temperature thermometer. For the initiator, pale yellow sodium-benzanilide (Na-BA) obtained by reacting equivalent sodium and benzanilide in tetrahydrofuran (THF) solvent was used. The prepared initiator was immediately put into a glass container under vacuum, and was diluted to a desired concentration. A polymerization unit comprising the glass container containing purified n-hexylisocyanate, which is an isocyanate monomer, the above-prepared initiator, and an anti-depolymerization agent was connected to a vacuum line to make its inside in high-degree vacuum and nitrogen atmosphere. Then, the polymerization unit was sealed and removed from the vacuum line. The inside of the polymerization unit was purged once more using a cleaning solution, and the glass container was broken in a prepared methanol constant-temperature. After the reactor inside and the reactants reached thermal equilibrium, the monomer was fed. The reaction was terminated by hydrochloric acid-methanol mixture solution (Comparative Examples 1 to 3 and Example 1) or methanol (Examples 2 to 6). The prepared polymer was precipitated in excess methanol, and then vacuum- dried (Comparative Examples 1 to 2) or freeze-dried (Examples 1 to 6).

TABLE 1
Polymer yield according to polymerization time

| | Polymerization | | | | | | | |
|---|---|---|---|---|---|---|---|---|
| | component | | | Reaction | Number-average molecular | | Polydispersity | |
| | (mmol) | | Reaction | temperature | weight (Mn) | | index | Yield |
| Classification | Na—BA¹⁾ | HIC²⁾ | time (min) | (° C.) | Calculated³⁾ | Measured⁴⁾ | (Mw/Mn)⁴⁾ | (%) |
| Comparative | 0.050 | 4.89 | 1 | −98 | 11,000 | 12,800 | 1.08 | 11 (89)⁵⁾ |
| Example 1 | | | | | | | | |
| Comparative | 0.061 | 4.53 | 10 | −90 | 11,500 | 11,700 | 1.09 | 30 (70)⁵⁾ |
| Example 2 | | | | | | | | |
| Comparative | 0.032 | 5.15 | 20 | −98 | 12,700 | 15,100 | 1.07 | 83 (17)⁵⁾ |
| Example 3 | | | | | | | | |
| Example 1 | 0.041 | 4.60 | 30 | −90 | 13,000 | 13,800 | 1.15 | 93 (7)⁵⁾ |
| Example 2 | 0.041 | 5.07 | 40 | −98 | 13,700 | 15,200 | 1.15 | 94 (6)⁵⁾ |
| Example 3 | 0.066 | 5.93 | 60 | −98 | 11,500 | 12,000 | 1.09 | 99 |
| Example 4 | 0.053 | 17.64 | 70 | −98 | 41,200 | 40,800 | 1.06 | 97 |
| Example 5 | 0.089 | 7.24 | 80 | −98 | 9,300 | 8,900 | 1.16 | 96 (4)⁶⁾ |
| Example 6 | 0.089 | 7.34 | 100 | −98 | 8,400 | 10,100 | 1.12 | 94 (6)⁶⁾ |

¹⁾Initiator: Sodium-benzanilide.
²⁾Isocyanate monomer: n-Hexylisocyanate.
³⁾Calculated value: (Monomer content/initiator content) × yield × molecular weight of hexylisocyanate (127.19).
⁴⁾Measured value: Measured at 40° C. using gel permeation chromatography (GPC) and light scattering (LS) units.
⁵⁾Unreacted monomer
⁶⁾Trimer yield

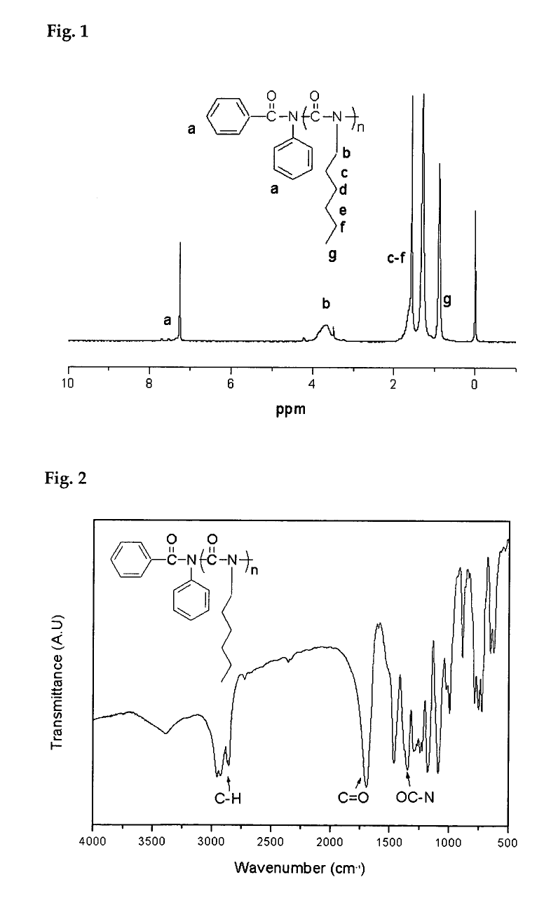

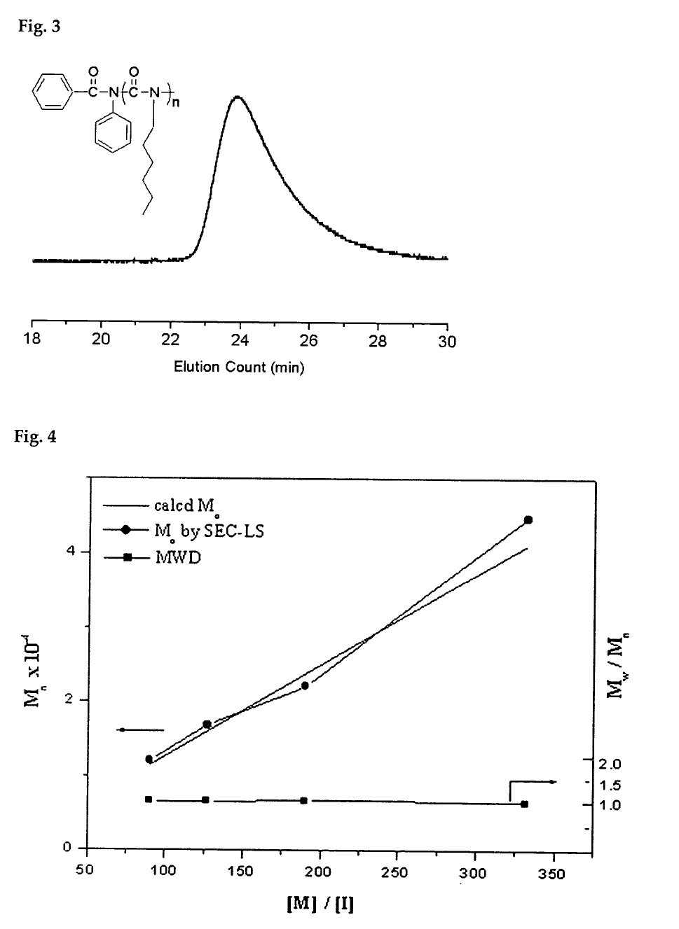

FIG. 1 is a ¹H-NMR spectrum of poly(n-hexylisocyanate) prepared in Example 3. FIG. 2 is a FT-IR spectrum of n-hexylisocyanate monomer and poly(n-hexylisocyanate), and FIG. 3 is their GPC spectrum. The presence of poly(n-hexylisocyanate) was identified from FIG. 1 and FIG. 2. And, it was identified that the prepared poly(n-hexylisocyanate) had a controlled molecular weight from the GPC spectrum of FIG. 3.

### Examples 7 to 10

Poly(n-hexylisocyanate) was prepared as in Example 1. Reaction molar ratio was differentiated as in the following Table 2 to identify its effect on the molecular weight. The reaction condition was 10⁻⁶ mmHg, and the reaction time was set to 60 to 70 minutes, which is the optimum reaction condition.

TABLE 2
Change in Molecular weight according to monomer/initiator ratio

| | Polymerization | | | | | | | |
|---|---|---|---|---|---|---|---|---|
| | component | | | Reaction | Number-average molecular | | Polydispersity | |
| | (mmol) | | Reaction | temperature | weight (Mn) | | index | Yield |
| Classification | Na—BA¹⁾ | HIC²⁾ | time (min) | (° C.) | Calculated³⁾ | Measured⁴⁾ | (Mw/Mn)⁴⁾ | (%) |
| Example 7 | 0.076 | 6.57 | 60 | −98 | 11,100 | 11,500 | 1.08 | 100 |
| Example 8 | 0.068 | 8.64 | 60 | −98 | 16,100 | 16,800 | 1.11 | 100 |
| Example 9 | 0.070 | 13.3 | 60 | −98 | 23,900 | 22,100 | 1.07 | 99 |
| Example 10 | 0.063 | 20.3 | 70 | −98 | 41,000 | 40,800 | 1.07 | 99 |

¹⁾Initiator: Sodium-benzanilide.
²⁾Isocyanate monomer: n-Hexylisocyanate.
³⁾Calculated value: (Monomer content/initiator content) × yield × molecular weight of hexylisocyanate (127.19).
⁴⁾Measured value: Measured at 40° C. using gel permeation chromatography (GPC) and light scattering (LS) units.

### Examples 11 to 16 and Comparative Examples 4 to 5

Poly(n-hexylisocyanate) was prepared as in Example 1. Reaction temperature was differentiated as in the following Table 3 to identify its effect on the polymerization. The reaction condition was 10⁻⁶ mmHg, and the reaction time was set to 10 minutes. 0° C. was obtained using ice and water. −45° C., −78° C., and −98° C. were obtained by slowly adding liquid nitrogen to a Dewar flask containing 3L of acetonitrile and methanol. A constant-temperature bath of −78° C. was prepared using dry ice and acetone. When a solvent in the constant-temperature bath froze completely, the frozen solid was cut to appropriate sizes using a glass rod to make it easy to stir the polymerization reactor.

TABLE 3
Yield according to reaction temperature

| | Polymerization | | | | | | | |
|---|---|---|---|---|---|---|---|---|
| | component | | | Reaction | Number-average molecular | | Polydispersity | |
| | (mmol) | | Reaction | temperature | weight (Mn) | | index | Yield |
| Classification | Na—BA¹⁾ | HIC²⁾ | time (min) | (° C.) | Calculated³⁾ | Measured⁴⁾ | (Mw/Mn)⁴⁾ | (%) |
| Comparative | 0.076 | 4.89 | 60 | 0 | 11,000 | — | — | 0 (100)⁶⁾ |
| Example 4 | | | | | | | | |
| Comparative | 0.068 | 8.64 | 5 | −45 | 820 | 11,800 | 1.17 | 5 (95)⁶⁾ |
| Example 5 | | | | | | | | |
| Example 11 | 0.082 | 7.05 | 5 | −78 | 8,570 | 10,100 | 1.16 | 83 (17)⁵⁾ |
| Example 12 | 0.036 | 4.41 | 10 | −78 | 6,470 | 11,600 | 1.09 | 95 (5)⁶⁾ |
| Example 13 | 0.085 | 7.91 | 20 | −78 | 4,470 | 9,000 | 1.09 | 90 (10)⁶⁾ |
| Example 14 | 0.041 | 5.07 | 40 | −98 | 13,700 | 15,200 | 1.15 | 94 (6)⁵⁾ |
| Example 15 | 0.066 | 5.93 | 60 | −98 | 11,500 | 12,000 | 1.09 | 99 |
| Example 16 | 0.089 | 7.24 | 80 | −98 | 9,300 | 8,900 | 1.15 | 92 (8)⁶⁾ |

¹⁾Initiator: Sodium-benzanilide.
²⁾Isocyanate monomer: n-Hexylisocyanate.
³⁾Calculated value: (Monomer content/initiator content) × yield × molecular weight of hexylisocyanate (127.19).
⁴⁾Measured value: Measured at 40° C. using gel permeation chromatography (GPC) and light scattering (LS) units.
⁵⁾Unreacted monomer
⁶⁾Trimer yield

It was identified that polymerization of polyisocyanate is greatly affected by the reaction temperature. When the reaction temperature was 0° C. (Example 14), 100% of the prepared polymer turned into trimers. It was also identified that the poly(n-hexylisocyanate) yield increases as the reaction temperature is decreased.

### Examples 17 to 19

Poly(n-hexylisocyanate) was prepared as in Example 1. Functional groups of the initiator were differentiated as in the following Table 4 to identify their effect on the polymerization. The reaction condition was 10⁻⁶ mmHg, and the reaction time was set to 60 minutes, which is the optimum reaction condition.

TABLE 4
Effect of initiator structure on polymerization

| | Polymerization component | | | | | | | | | |
|---|---|---|---|---|---|---|---|---|---|---|
| | (mmol) | | | | Reaction | Reaction | Number-average molecular | | Polydispersity | |
| | (R₁—C(═O)N—R₁)Na¹⁾ | | | | time | temperature | weight (Mn) | | index | Yield |
| Classification | R₁ | R₂ | mmol | HIC²⁾ | (min) | (° C.) | Calculated³⁾ | Measured⁴⁾ | (Mw/Mn)⁴⁾ | (%) |
| Example 17 | C₆H₅ | CH₃ | 0.11 | 9.13 | 60 | −98 | 10,400 | 11,500 | 1.11 | 99 |
| Example 18 | C₆H₅ | CF₃C₆H₄ | 0.12 | 9.34 | 60 | −98 | 9,800 | 10,900 | 1.12 | 99 |
| Example 19 | C₆H₅ | C₁₀H₇ | 0.11 | 9.15 | 60 | −98 | 10,500 | 11,400 | 1.08 | 100 |

¹⁾Initiator:
²⁾Isocyanate monomer: n-Hexylisocyanate.
³⁾Calculated value: (Monomer content/initiator content) × yield × molecular weight of hexylisocyanate (127.19).
⁴⁾Measured value: Measured at 40° C. using gel permeation chromatography (GPC) and light scattering (LS) units.

It was identified that poly(n-hexylisocyanate) having a variety of alkyl and aromatic groups were synthesized quantitatively.

### Examples 20 and 21

A block copolymer of n-hexylisocyanate (HIC) and triethoxysilylpropylisocyanate (TESPI) was prepared to identify the living characteristics.

First, n-hexylisocyanate was polymerized in a −98° C. methanol-liquid nitrogen constant-temperature bath for 60 minutes. Then, triethoxysilylpropylisocyanate was polymerized at the same condition for 20 minutes. Methanol was added to terminate the reaction, and the yield was calculated by measuring the weight of the obtained polymer. The following Table 5 shows the block copolymerization result. From the NMR and GPC analysis results, it was identified that the molecular weight of the block copolymer increased.

TABLE 5
Comparison of living characteristics

| | Polymerization component | | | | | | | |
|---|---|---|---|---|---|---|---|---|
| | (mmol) | | | | Reaction | Number-average | | |
| | | 1st | 2nd | Reaction | temperature | molecular weight (Mn) | | Yield |
| Classification | Initiator | monomer | monomer | time (min) | (° C.) | Calculated | Measured | (%) |
| Example 20 | Na—BA | HIC (8.24) | TESPI (2.45) | 60/20 | −98 | 20,900 | 20,900 | 98 |
| | (0.078) | | | | | | | |
| Example 21 | Na—BA | TESPI | HIC (5.37) | 20.60 | −98 | 12,700 | 12,700 | 97 |
| | (0.101) | (2.61) | | | | | | |

As described above, the present invention polymerizes a polyisocyanate with controlled molecular weight, narrow molecular weight distribution, and controlled structure using a novel initiator made of stable amidate anion or oxyanion for anionic living polymerization of isocyanate monomer. Since the main chain of the obtained polyisocyanate is linked by amide bonds, the polymer is relatively rigid. Also, since it has a spiral structure, it is useful for preparing optical materials, such as liquid crystal materials, chiral materials, and optical switches.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. An initiator for polymerizing polyisocyanate represented by the following Formula 1: 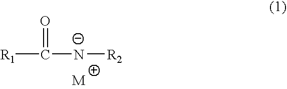
wherein M is an alkali metal including Li, Na, K, and Cs; and R1 and R2 are independently an alkyl or aryl group.

2. A method for preparing polyisocyanate by anionic polymerization of isocyanate monomers using metal amidate represented by the following Formula 1 as a polymerization initiator: 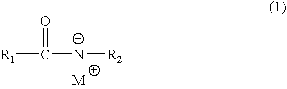
wherein M is an alkali metal including Li, Na, K, and Cs; and R1 and R2 are independently an alkyl or aryl group.

3. The method for preparing polyisocyanate according to claim 2, wherein said polymerization is carried out at high-degree vacuum of 10⁻⁶ to 10⁻⁴ mmHg and an extremely low temperature of −60 to −100° C. for 30 to 150 minutes using a metal amidate initiator represented by Formula 1 and a tetrahydrofuran solvent.

4. The method for preparing polyisocyanate according to claim 2, wherein said polyisocyanates is a homopolymer or a copolymer.
